(19) United States
(12) Patent Application Publication
(10) Pub. No.: US 2002/0010833 A1
(43) Pub. Date: Jan. 24, 2002

(54) DISC DEVICE

(76) Inventor: MITSUGU YOSHIHIRO, KANAGAWA (JP)

Correspondence Address: William E Vaughan, Bell Boyd and Lloyd LLC, PO box 1135, Chicago, IL, 60690-1135, US

(21) Appl. No.: 09/201,415

(22) Filed: Nov. 30, 1998

(30) Foreign Application Priority Data
Feb. 21, 1997 (JP) P09-037208

(51) Int. Cl. G06F 12/16

(52) U.S. Cl. 711/112; 710/52; 714/5

(57) ABSTRACT

A hard disc device for recording and/or reproducing picture signals in which continuous information signals such as picture signals can be recorded or reproduced by a structure simplified on a whole. The recording and/or reproducing of information signals is re-tried within a range of a preset limit time. The capacities of buffer memories 11a, 1e are set so as to store the information signals corresponding to this limit time.

### BACKGROUND OF THE INVENTION

1. Field of the Invention

This invention relates to a disc device, and is applicable to, for example, a hard disc device for generating picture signals. The present invention limits retry time and sets the capacity of a buffer memory in association with this limited time to enable continuous information signals, such as picture signals, to be recorded and reproduced by an overall simplified structure.

2. Description of the Related Art

If information signals made up of picture signals are recorded in a conventional video tape recorder, emphasis is put on data continuity in recording and/or reproducing information signals, so that, by executing interleaving or appending error correction codes, there is no risk of possible interruption of continuous data.

On the other hand, in a hard disc device applied to a storage device for a computer, it is verified by processing such as read-after-write or error detection, whether or not desired data have been recorded or reproduced correctly. If, in this type of the hard disc device, data cannot be recorded and/or reproduced correctly, the retry processing is repeated, or the error correction processing is executed when the necessity arises. In this type of the hard disc device, recording and/or reproducing processing is carried out in this manner with emphasis put on reliability of recorded or reproduced data.

If a hard disc device can be used for recording and/or reproducing of picture or speech signals, locating operations, for example, can be simplified, thus simplifying editing operations of this sort of information signals. If, in this case, picture or speech signals can be recorded or reproduced by a hard disc device for a computer, this sort of the editing device can be constructed by this component part exhibiting correspondingly advanced universality or adaptability to simplify the structure of this sort of the recording and/or reproducing apparatus.

However, in the hard disc device for computers, retry operations are repeated in order to put utmost emphasis on data reliability. Thus, if the hard disc device is applied to recording or reproduction of the picture or speech signals, there my be occasions wherein picture or speech signals are interrupted due to repetition of the retrial operations.

As a method for resolving the above inconvenience, it may be contemplated to improve reliability in the hard disc device to substantially eliminate the necessity for retry operations. However, in this case, it becomes difficult to use a general-purpose device, such as a hard disc device for a computer. Although the retry operations may be eliminated by designing even if video data cannot be reproduced correctly, it is feared in such case that uncorrectable bit errors occur frequently in the reproduced picture signals to render it difficult to reproduce continuous picture signals.

### SUMMARY OF THE INVENTION

It is therefore an object of the present invention to provide a disc device capable of recording and/or reproducing continuous information signals, such as picture signals, by a structure which is simplified on the whole.

The present invention provides a disc apparatus for recording and/or reproducing compressed information signals for a disc-shaped recording medium via a buffer memory, wherein, if the information signals cannot be correctly recorded or reproduced for the disc-shaped recording medium, recording and/or reproducing of the information signals is re-tried within a range of a preset limit time, and wherein the buffer memory has its memory set so as to store the information signals corresponding to the limit time.

If recording and/or reproducing for information signals is retried within the range of a preset limit time, it is possible to reduce the occurrences of bit errors difficult to correct to a practically allowable range. If the capacity of the buffer memory is set so as to be capable of storing an amount of information signals corresponding to this limit time, the information signals, such as picture signals, can be recorded and/or reproduced without intermission, as the capacity of the buffer memory is set to a practically sufficient small value.

That is, by re-trying the recording and/or reproducing of information signals within a preset limit time, and by setting the capacity of the buffer memory so as to be capable of storing the volume of the information signals corresponding to this limit time, the continuous information signals can be recorded and/or reproduced without intermission, as the buffer memory is constructed to a practically sufficient small value, in order to enable the continuous information signals to be recorded and/or reproduced by a correspondingly simplified structure.

### BRIEF DESCRIPTION OF THE DRAWINGS

FIG. 1 is a block diagram showing the overall structure of an editing device embodying the present invention.

FIG. 2 is a block diagram showing a video signal system of a hard disc array applied to the editing device.

FIG. 3 is a block diagram showing an audio signal system of the hard disc array shown in FIG. 2.

### DESCRIPTION OF THE PREFERRED EMBODIMENTS

Referring to the drawings, preferred embodiments of the present invention will be explained in detail.

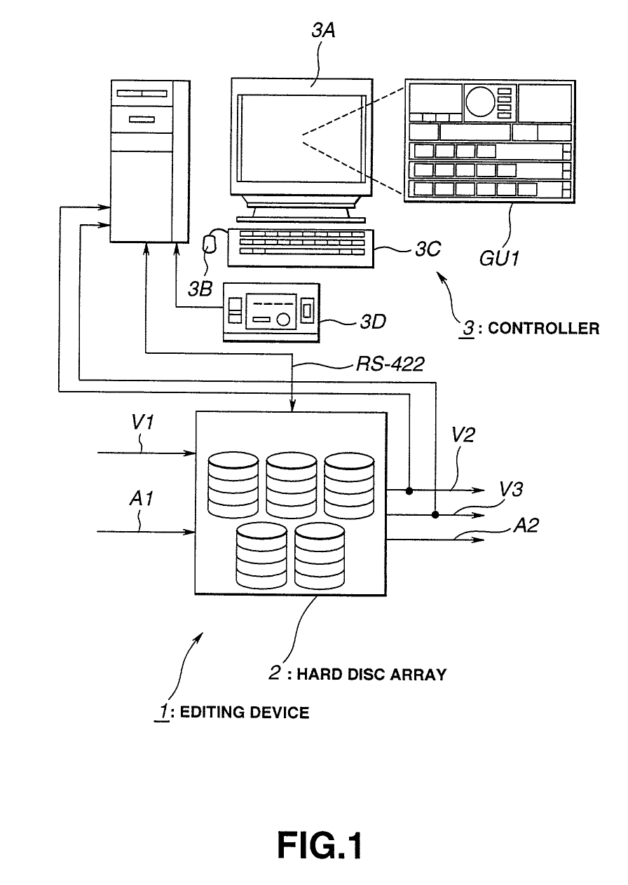

FIG. 1 shows a block diagram showing an editing device embodying the present invention. This editing device 1 records sequentially inputted video signals V1 and audio signals A1 on a hard disc array 2, while editing and outputting the recorded video signals V1 and audio signals A1.

Specifically, the editing device 1 has a controller 3, configured as a computer, and is designed so that the operation of the entire structure is switched to record sequentially inputted video signals V1 and audio signals A1, under control by the controller 3, by actuating a mouse 3B or a keyboard 3C in accordance with a graphical user interface (GUI) displayed on a monitor device 3A. Also, monitor pictures, such as video signals of the recorded video signals V2 or V3, are furnished to a user, while an editing list is prepared in accordance with actuations by the user and video and audio signals recorded on the hard disc array 2 are reproduced and outputted in accordance with the prepared editing list.

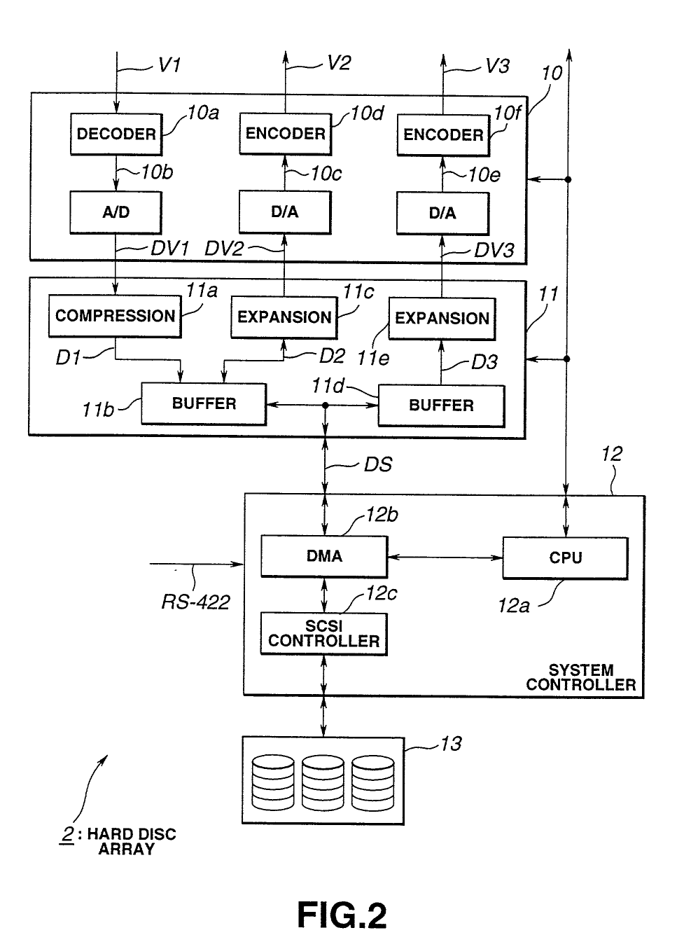

FIG. 2 is a block diagram showing a video signal processing system of the hard disc array 2. In this hard disc array 2, a video data input/output unit 10 converts the video signals V1 entered to this editing device 1 into digital video signals DV1 of a predetermined format to output the digital video signals DV1 to a video data processing unit 11. Also, a video data input/output unit 10 converts the digital video signals DV and DV3, outputted by the video data processing unit 11, into video signals V2 and V3, which are analog signals. These video signals V2 and V3 are outputted to the controller 3 and to external equipments

This editing device 1 is configured for inputting/outputting composite video signals. In the video data input/output unit 10, a decoder 10a converts the video signals V1 composed of composite video signals into component video signals, which are outputted. These component video signals are A/D are converted by an analog/digital converting circuit (A/D converter) 10b to output digital video signals DV1 of a predetermined format composed of luminance data and chroma data.

The digital/analog converting circuit (D/A converter) 10c digital/analog converts the digital video signals DV2, outputted by the video data processing unit 11, by digital/analog conversion, in order to output component video signals made up of luminance signals and chroma signals. These component video signals, outputted by the D/A converter 10c, are converted by an encoder 10d, arranged next, into output composite video signals V2. Similarly, a digital/analog converting circuit (D/A converter) 10e digital/analog converts the digital video signals DV3, outputted by the video data processing unit 11, by digital/analog conversion, in order to output the component video signals. These component video signals, outputted by the D/A converter 10c, are converted by an encoder 10f, arranged next, into output composite video signals V3.

The video data processing unit 11 compresses the digital video signals DV1 inputted by the video data input/output unit 10 to output the resulting compressed signals to a system controller 12. The video data processing unit 11 also expands video data inputted from the system controller 12 to generate digital video signals DV2 and DV3 which are outputted to the video data input/output unit 10.

That is, in the video data processing unit 11, a compression circuit 1a compresses digital video signals DV1 under the MPEG (Moving Picture Experts Group) standard to generate video data D1 which is outputted to a buffer 11b at a preset data transfer speed Rv (Mbyte/sec). Also, in the video data processing unit 11, an expansion circuit 11c receives video data D2 compressed by the MPEG standard via buffer 11b at a preset data transfer rate Rv and expands this video data D2 to output the digital video signals DV2.

The buffer 11b is constituted by a memory of the FIFO (first-in first-out) circuit configuration and has its operation switched under control by the system controller 12. Specifically, the buffer 11b outputs the video data D1 entered from the compression circuit 11a to the system controller 12, while outputting the video data DS fed from system controller 12 and outputting the video data inputted from the compression circuit 11a in place of the video data inputted from the system controller 12 to the expansion circuit 11c. Thus, the buffer 11b is configured to record video data on plural hard discs 13, monitor the video data recorded on these plural hard discs 13 and to monitor compressed video data D1 of the sequentially inputted video signals V1 as the occasion may demand.

When inputting/outputting the video data DS in this manner, the buffer 11b inputs/outputs the video data D1 and D2 between it and the compression circuit 11a or the expansion circuit 11c at a data transfer rate Rv (Mbyte/sec) corresponding to the data processing speed of the compression circuit 11a and the expansion circuit 11c, while inputting/outputting the video data DS between it and the system controller 12 at a data transfer rate Rh (Mbyte/sec) higher than the data transfer rate Rv (Mbyte/sec). Thus, the buffer 11b inputs/outputs the video data D1 and D2 between it and the system controller 12 or the expansion circuit 11c substantially continuously, while inputting/outputting the video data DS between it and the system controller 12.

The buffer 11b has its capacity B (Mbyte) set to a practically small enough value satisfying the following relation:

B>Tr×Rv (1)

where Rv is the data transfer rate (Mbyte/sec) between it and the compression circuit 11a or the expansion circuit 11c and Tr is the retry limit time which will be explained subsequently. In the editing device 1, the buffer 11b is configured to store the video data D1 outputted by the compression circuit 11a with this retry limit time to enable the video data DS to be recorded or reproduced without interruptions with the necessary minimum capacity.

Similarly to the buffer 11b, the buffer 11d is constituted by a memory of a FIFO circuit configuration adapted to hold the video data DS entered from the system controller 12 and which outputs the video data DS thus held to an expansion circuit 11e at a data transfer rate Rv corresponding to the data processing speed of the expansion circuit 11e. Similarly to the buffer 11b, the buffer 11d has the data transfer rate Rh (Mbyte/sec) and the data transfer rate Rv (Mbyte/sec) set between it and the system controller 12 and between it and the expansion circuit 11e, respectively, while having its capacity B set to a sufficiently small value for practical use for these data transfer rates Rh, Rv (Mbyte/sec) insofar as the equation (1) is met. Thus, in the editing device 1, the buffer 11d is configured for storing the video data D3 to be sent to the expansion circuit 11e with the retry limit time Tr.

The expansion circuit 11e expands the video data DS outputted by this buffer 11d.

The system controller 12 inputs/outputs a control command, for example, between it and the controller 3, in accordance with the communication format of RS-422, and executes a series of processing operations by a central processing unit (CPU) 12a in accordance with the control command. Thus, the system controller 12 controls the entire operation of the hard disc array 2.

In this system controller 12, a direct memory access controller (DMA) 12b has its operation switched under control by the central processing unit 12a in order to input/output data between it and the video data processing unit 11 and in order to output the video data between it and the small computer system interface (SCSI) controller 12c. The direct memory access controller 12b at this time controls the timing of the video data DS inputted from the video data processing unit 11, while controlling the timing of the video data DS inputted from the SCSI controller 12c to output the video data DS to the video data processing unit 11.

The SCSI controller 12c issues a control command to the plural hard discs 13 allocated to the recording of video signals, under control by the central processing unit 12a, while allocating and recording the video data DS inputted from the direct memory access controller 12b in a distributing fashion in these plural hard discs 13 and reproducing the video data DS from these hard discs 13 to output the reproduced data to the direct memory access controller 12b.

In the SCSI controller 12c, if a preset volume of the video data DS is stored during recording in the buffer 11b, the video data DS is fed from the buffer 11b via the direct memory access controller 12b so as to be recorded on the hard disc 13. The SCSI controller 12c then causes the video data DS to be read out intermittently from the buffer 11b to record the read-out video data DS on the hard disc 13 to secure a preset vacant area in the buffer 11b.

Similarly, when the vacant areas in the buffers 11b, 11d are decreased during reproduction to less than a preset value, the hard disc 13 intermittently drives the hard disc 13 to output the video data DS to prevent interruption of the video data DS outputted to the expansion circuits 11c, 11e.

Under control by the SCSI controller 12c, the hard disc 13 records the sequentially inputted video data DS or reproduces the recorded video data DS to output the reproduced data. During recording of the video data, the hard disc 13 records the video data DS as it appends predetermined error correction code to execute the read-after-write processing. At this time, the hard disc repeats the retry processing operations within the previously set number of times of limitation.

It is noted that the number of times of retry operations is set to a value such that, even in such cases wherein it is difficult to record the video data DS correctly, the correct video data DS can be reproduced by error correction by the error correction codes. In the present embodiment, the above-described limitation time Tr is set such that retry is repeated within this limited number of times and retry processing comes to a close within the extent of the retry limit time Tr.

It is thus possible with the editing device 1 to set the capacity of the buffer 11b to a sufficiently small value B for practical application and to reduce the occurrence of bit errors difficult to correct to a sufficiently low range for practical application to enable uninterrupted recording of the video signals V1.

If, during reproduction, the video data DS cannot be reproduced correctly by the error detection processing, the hard disc 13 repeats the retry processing within a range of similar number of times of limitation. It is noted that the number of times of retry at the time of reproduction is set to a value such as to enable correct video data DS to be reproduced by error correction by the error correction codes. In the present embodiment, retry operations are repeated within the range of the limit time Tr by this setting of the number of times of limitation.

Thus, the editing device 1 can set the capacities of the buffers 11b, 11c to a sufficiently small value B for practical application to reduce the occurrence of bit errors difficult to correct in order to enable the video signals V1 to be reproduced without interruptions.

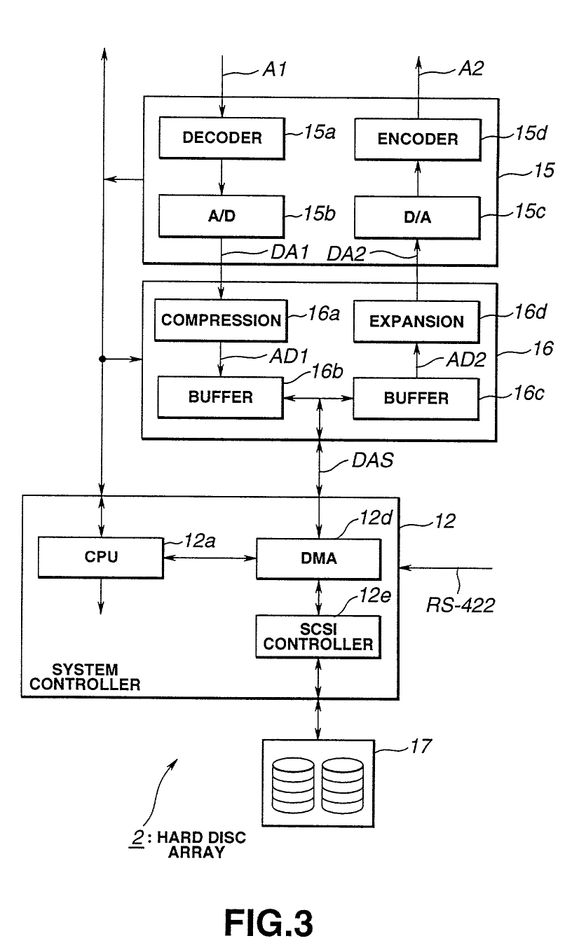

FIG. 3 shows a block diagram showing the processing system of audio signals of the hard disc array 2. In this hard disc array 2, an audio data input/output unit 15 converts the audio signal A1 inputted to this editing device 1 into digital audio signals DA1 of a predetermined format to output the digital audio signals DA1 to an audio data processing unit 16. On the other hand, the audio data input/output unit 15 converts the digital audio signals DA2 outputted by the audio data processing unit 16 into analog audio signals A2 which are outputted to the controller 3 and to an external equipment.

That is, a decoder 15a in the audio data input/output unit 15 converts the analog audio signals A1 to signals of a format suited for the next following digital signal processing to output the resulting signals. In an analog/digital converting circuit (A/D converter) 15b, next following the decoder 15a, the audio signals are analog/digital converted to generate the digital audio signals DA1 of the predetermined format, which signals DA1 are outputted.

The digital audio signals DA2, outputted by the audio data processing unit 16, are digital/analog converted by a digital/analog converting circuit (D/A converter) 15c so as to be outputted as audio signals. The audio signals, outputted by the digital/analog converting circuit 15c, are converted by an encoder 15d, next following the digital/analog converting circuit 15c, into analog audio signals A2 of a predetermined format which are outputted.

An audio signal processor 16 compresses the digital audio signals DA1, sent from the audio data input/output unit 15, to output the resulting data to the system controller 12. The audio data processing unit 16 also expands the audio data entered from the system controller 12 to generate digital audio signals DA2 which are outputted to the audio data input/output unit 15.

That is, in the audio data processing unit 16, a compressing circuit 16a compresses the digital audio signals DA1 to generate audio data AD1 which is outputted to a buffer 16b at a preset data transfer rate Rva (Mbyte/sec).

The buffer 16b is constituted by a memory of the FIFO circuit structure and has its operation switched under control by the system controller 12. That is, the buffer 16b outputs the analog audio data AD1 sent from the compressing circuit 16a to the system controller 12, while outputting the audio data sent from the system controller 12 to an expansion circuit 16d. Thus, the buffer 16b is configured for recording audio data on plural hard discs 17 via system controller 12 and for monitoring audio data recorded on these hard discs 17.

In inputting/outputting audio data DAS, the buffer 16b is fed with the audio data AD1 at the data transfer rate Rva (Mbyte/sec) corresponding to the data processing rate of the compressing circuit 16a, while it inputs/outputs the audio data DAS between it and the system controller 12 at a data transfer rate Rha (Mbyte/sec) higher than the data transfer rate Rva (Mbyte/sec). Thus, the buffer 16b inputs/outputs audio data AD1 substantially continuously between it and the compressing circuit 16a, while intermittently inputting/outputting audio data DAS between it and the system controller 12.

The buffer 16b has its capacity Ba (Mbyte/sec) set to a sufficiently small value for practical application with respect to the data transfer rate Rva (Mbyte/sec) within a range of the following relation:

Ba>Tra×Rva (2)

where Tra is the limit time which is the same as the retry limit time of the above-mentioned hard disc 13. This enables the editing device 1 to record continuous audio data DAS within the range of the necessary minimum capacity without intermission.

Similarly to the buffer 16b, the buffer 16c is constituted by a memory of the FIFO circuit configuration, and holds the audio data DAS entered from the system controller 12, while outputting the audio data DAS it holds to the expansion circuit 16d at a data transfer rate Rva corresponding to the data processing speed of the expansion circuit 16d. Similarly to the buffer 16d, the buffer 16c has its data transfer rate Rha (Mbyte/sec) and the data transfer rate Rva (Mbyte/sec) set with respect to the system controller 12 and to the expansion circuit 16d. Moreover, the buffer 16c has its capacity Ba set to a sufficiently small capacity Ba for practical application in relation to the data transfer rates Rha and Rva (Mbyte/sec) within a range satisfying the relation (2).

The expansion circuit 16d expands the audio data DAS outputted by this buffer 16c to output digital audio signals.

In the present audio signal processing system, the system controller 12 performs switching control of the entire operation in synchronism with the video system under control by the central processing unit 12a.

That is, in the present system controller 12, the direct memory access controller (DMA) 12d switches the operation under control by the central processing unit 12a to input/output audio data DAS between it and the audio data processing unit 16, while inputting/outputting the audio data DAS between it and the SCSI controller 12e. The direct memory access controller 12d at this time controls the timing of the audio data DAS entered from the audio data processing unit 16 to output the audio data DAS to the SCSI controller 12e, while controlling the timing of the audio data DAS entered from the SCSI controller 12e to output the resulting data to the audio data processing unit 16.

The SCSI controller 12e issues control commands to plural hard discs 17 allocated for recording audio signals, under control by the central processing unit 12a, to record the audio data DAS sent from the direct memory access controller 12d in a distributed fashion on the plural hard discs 17. Also, the SCSI controller 12e reproduces the audio data DAS from the plural hard discs 17 to output the reproduced data to the direct memory access controller 12d.

If, during recording, a preset data volume of the video data DS is stored in the buffer 11b, the SCSI controller 12e intermittently inputs the audio data DAS from the buffer 16b via the direct memory access controller 12d, under control by the central processing unit 12, in order to receive the audio data DAS intermittently from the buffer 16b via the direct memory access controller 12d and in order to record the input audio data DAS on the hard disc 17. Similarly, during reproduction, the SCSI controller 12e intermittently drives the hard disc 17 to reproduce audio data DAS so that there is no risk of intermission of the audio data DAS outputted by the buffer 16c to the expansion circuit 16d.

The hard disc 17 records the sequentially entered audio data DAS, under control by the SCSI controller 12e, while reproducing and outputting the recorded audio data DAS. During recording of the audio data, the hard disc 17 appends preset error correction codes to the audio data DAS being recorded to execute the read-after-write processing. If it has been detected by this read-after write that recording of audio data has resulted in failure, retry processing is repeated. At this time, the hard disc 17 repeats retry processing within a range of a previously set number of times of limitation.

The number of times of retry is set so that, even if it is difficult to record the audio data DAS correctly, correct audio data can be reproduced on error correction by error correction codes. In the present embodiment, retry processing is adapted to be repeated within the range of the limit time Tr subject to this setting of the number of times of limitation.

Thus it is possible with the editing device 1 to set the capacity of the buffer 16b to a sufficiently small value for practical application to reduce the occurrences of the bit errors difficult to correct to a practically tolerable level to render it possible to record the audio signal A1 without intermission.

If it has been found on error detection at the time of reproduction that recording of the audio data DAS has resulted in failure, retry processing is performed within the similar range of the number of times of limitation. It is noted that the number of times of the retry processing at the time of reproduction is set so that correct audio data DAS can be reproduced by error correction by the error correction code. In the present embodiment, the retry processing is repeated within the number of times of limitation so that the reproducing processing will be completed within the limit time Tr.

It is thus possible with the editing device 1 to set the capacity of the buffer 16c to a sufficiently small value Ba to reduce the occurrence of bit errors difficult to correct to a sufficiently small range for practical application to enable the analog audio signals A2 to be reproduced without intermission.

In the above-described editing device 1, shown in FIG. 1, the video signals V1 and the audio signals A1, sequentially entered, are recorded on the hard disc array 2 and the video signals V2, V3 and the audio signals A2 recorded on the hard disc array 2 are reproduced and displayed on a monitor 3A, subject to actuation by an operator. The video signals V2, V3 and the audio signals A2 recorded on the hard disc array 2 are reproduced and outputted to an external equipment in accordance with an editing list which the operator has set on monitoring the display on the monitor 3A.

Of the video signals V1 to V3 (FIG. 2) and audio signals, recorded or reproduced in this manner, the video signal V1, sequentially entered, is converted by a decoder 10a of the video data input/output unit 10 into component video signals and subsequently converted by the next following digital/analog converter 10b into a digital video signal DV1. This digital video signal DV1 is compressed by the compression circuit 11a of the video data processing unit 11 to generate video data Digital audio signals DA1 which are sequentially stored in the buffer 11b at a data transfer rate Rv (Mbyte/sec).

This video data Digital audio signal DA1 is farther sent to the system controller 12 from the buffer 11b so as to be recorded by this system controller 12 in a distributed fashion in plural hard discs 13. The video data digital audio signals DA1 is intermittently read out from the buffer 11b at a data transfer rate Rh (Mbyte/sec) higher than the transfer rate at the time of inputting to the buffer 11b for recording on the plural hard discs 13, so that the buffer 11b is not subjected to overflowing and so that a predetermined vacant capacity is secured in the buffer 11b.

In each hard disc 13, an error correction code is appended to the video data, so that, in recording the video data, it is checked, by read-after-write and error detection, whether or not recording has been made correctly. If correct recording has not been made, retry processing is repeated within the range of the preset number of times of limitation so that the video data is recorded on the hard disc 13 within the time of limitation. If the number of times of limitation is set to a value which will allow for correct reproduction of the video data DS by error correction employing the error correction code, the video data DS is recorded on each hard disc 13 so that occurrence of bit errors difficult to correct at the time of reproduction will be reduced to a level sufficient low for practical application.

With the editing device 1, the video data Digital audio signals DA1 is stored in succession in the buffer 11b by this retry processing in excess of the usual vacant capacity which prevails in the absence of the retry processing. If the retry processing comes to a close, the video data D1 are sequentially stored in succession in the hard disc 13 so that the vacant capacity of the buffer 11b will be of a preset value. Since the capacity of the buffer 11b is set with respect to the limit time Tr by the number of times of limitation of retry and the data transfer rates Rh, Rv so that the relation (1) is met, overflow of the buffer 11b can be effectively prevented from occurring even on repetition of retry processing. The buffer 11b can be constructed with a sufficiently small capacity for practical application, so that continuous video signals can be recorded without intermission with a correspondingly simple structure.

During reproduction, the video data DS are reproduced from the hard disc 13 under control by the system controller 12 so as to be entered via buffers 11b, 11d to the expansion circuits 11c and 11e. The video data D2, D3 are expanded to generate digital video signals DV2, DV3, which are converted into output analog composite video signals V2, V3.

These video data are outputted from the buffers 11b, 11d at the data transfer rate Rv corresponding to the processing rate in the expansion circuits 11c, 11d, while being sent to the buffers 11b, 11d at the data transfer rate Rh (Mbyte/sec) higher than the data transfer rate Rv. It is noted that the video data are intermittently reproduced from the hard disc 13 and sent to the buffers 11b, 11d so that no overflow will occur in the buffers 11b, 11d and so that video data D2, D3 in excess of a pre-set value will be held in the buffers 11b, 11d.

Also, it is checked, by the error detection processing in the hard disc 13, whether or not reproduction has been made correctly. If reproduction has not been made correctly, retry processing is repeated within a range of the preset number of times of limitation so that the video data are reproduced within the limit time Tr. Since the number of times of limitation is set to a value such that correct video data DS can be reproduced by error correction by the error correction code, the occurrence of bit errors difficult to correct is reduced to a sufficiently low level for practical application as the video data DS are reproduced from each hard disc 13.

In the editing device 1, the continuous video data D1 are sequentially reproduced from the hard disc 13 so as to be stored in the buffers 11b, 11b, so that, as a result of the retry processing, the volume of data of the video data D3 stored in the buffers 11b, 11d will be reduced to lower than the usual data volume, which is the data volume prevailing in the absence of the retry processing, and so that, when the retry processing comes to a close, the data volume will be of a preset value.

With the editing device 1, in which the capacity B of the buffers 11b, 11d is set so as to satisfy the relation (1) for the limit time Tr corresponding to the number of times for retry limitation and the data transfer rates Rh, Rv, the video data D2, D3 can be supplied without intermission to the expansion circuits 11c, 11e even if retry processing is repeated, whereby the video signals can be outputted without intermission from the editing device 1. By constructing the buffers 11b, 11d with a sufficiently small capacity B for practical application, continuous video signals can be reproduced without intermission by a correspondingly simplified structure.

On the other hand, audio signals A1 (FIG. 3) are converted by an analog/digital converting circuit 15b of the audio data input/output unit 15 into digital audio signals DA1 which are compressed in the next following compressing circuit 16a of the audio data processing unit 16 to generate audio data AD1. These audio data AD1 are sequentially stored in the buffer 16b at a data transfer rate Rva (Mbyte/sec) so as to be recorded via system controller 12 in the hard disc 17 allocated for audio signals.

Conversely, the audio data DAS reproduced from the hard disc 17 are stored via system controller 12 in the buffer 16e and expanded by the next following expansion circuit 16d. These expanded data are converted by the audio data input/output unit 15 into output analog signals.

In the inputting/outputting for the buffers 16b, 16c in the editing device 1, the retry time of the hard disc 17 is limited by the number of times of retry and the capacities of the buffers 16b, 16c are set to values sufficient to meet the relation (2) within this range of limitation. It is thus possible to construct the buffers 16c, 16d to a sufficiently small capacity B for practical application to record/reproduce continuous audio signals without intermission.

In the above arrangement, in which the retry time for the hard discs 13, 17 is limited by the number of times of retry and in which the capacities of the buffers 11b, 11d, 16b, 16c are set in such a manner as to store the amount of the video and audio data corresponding to this limit time, it is possible to construct the buffers 11b, 11d, 16b, 16c with a sufficiently small capacity B for practical application to record/reproduce audio signals without intermission. The result is that video and audio signals can be recorded and/or reproduced by a correspondingly simpler overall structure.

Although the retry time of the hard discs 13, 17 is limited in the above embodiment by the number of times of retry limitation, the present invention is not limited to this illustrative structure and the retry time can be directly limited by time management.

In the above embodiment, the retry time of the hard discs 13, 17 is limited by the number of times of retry limitation. The present invention, however, is not limited to this embodiment and can be broadly modified so that retry limit time will be set to various different values as the occasion may demand. That is, there are occasions wherein data restoration can be achieved to an extent practically sufficient by, for example, interpolation. In such case, the retry limit time can be reduced to a shorter value.

In the above-described embodiment, the retry limit time is set by the previously set number of times of retry. The present invention, however, is not limited to this embodiment since the retry limit time can be varied as the occasion may demand. Specifically, if once the retry processing is executed, the time T:

$$T = \frac{B}{Rh - Rv} \qquad ( 3 )$$

is required after executing the retry until the buffer contents are charged with video data. Thus, during this time T, the retry time can be limited by this time T instead of by the limit time Tr and the limit time Tra to secure continuity of the video data during this time T.

In the above-described embodiment, information signals composed of the video and audio signals are recorded and/or reproduced by the hard disc device. The present invention, however, is not limited to this embodiment and can be broadly applied to the cases of recording or reproducing information signals composed of video and audio signals for a variety of disc-shaped recording mediums, such as optical discs.

What is claimed is:

1. A disc apparatus for recording and/or reproducing compressed information signals for a disc-shaped recording medium via a buffer memory, wherein
if the information signals cannot be correctly recorded or reproduced for the disc-shaped recording medium, recording and/or reproducing of said information signals is re-tried within a range of a preset limit time;
said buffer memory having its memory set so as to store said information signals corresponding to said limit time.
